(19) United States
(12) Patent Application Publication
(10) Pub. No.: US 2018/0123789 A1
(43) Pub. Date: May 3, 2018

(54) APPARATUS AND METHOD FOR GENERATING A KEY IN A PROGRAMMABLE HARDWARE MODULE

(71) Applicant: Siemens Aktiengesellschaft, München (DE)

(72) Inventor: DOMINIK MERLI, DONAUWÖRTH (DE)

(21) Appl. No.: 15/565,472

(22) PCT Filed: Mar. 24, 2016
(86) PCT No.: PCT/EP2016/056620

§ 371 Date: Oct. 10, 2017

(30) Foreign Application Priority Data
Apr. 14, 2015 (DE) 102015206643.6

(51) Int. Cl. H04L 9/08; H03K 19/177; G09C 1/00

(52) U.S. Cl. CPC H04L 9/0877; H04L 9/0643; G09C 1/00; H03K 19/17768

(57) ABSTRACT

A method for generating a key in a programmable hardware module is provided, wherein the programmable hardware module has a bitstream containing configuration settings of the programmable hardware module. The device has a readout unit for reading at least one part of the bit stream, a generating unit for generating a key based on a cryptographic function and the at least one part of the bit stream, and a memory unit for storing the generated key. By means of the device according to the invention, a key can be generated in a simple manner using already existing information. Further provided is a programmable hardware module having such a device, and to a method for generating a key in a programmable hardware module.

### CROSS-REFERENCE TO RELATED APPLICATIONS

This application claims priority to PCT Application No. PCT/EP2016/056620, having a filing date of Mar. 24, 2016, based off of German application No. 10 2015 206 643.6 having a filing date of Apr. 14, 2015, the entire contents both of which are hereby incorporated by reference.

### FIELD OF TECHNOLOGY

The following relates to an apparatus for generating a key in a programmable hardware module. Moreover, the present invention relates to a programmable hardware module having such an apparatus. Furthermore, the present invention relates to a method for generating a key in a programmable hardware module.

### BACKGROUND

Programmable hardware modules such as FPGAs (Field Programmable Gate Arrays) use bit streams that contain all the configuration settings of the FPGAs. Application circuits and internal secrets for security applications are stored in such a bit stream.

In SRAM based FPGAs, the bit stream is stored externally and loaded during switching-on. This means that an attacker can access the bit stream, can analyze it and manipulate it. Therefore, secrets or keys are not stored in such a bit stream.

In FPGAs, keys can be generated by using physical unclonable functions, for example. Keys can be generated from physical properties, such as delay time differences of signal paths, or hardware circuits.

### SUMMARY

An aspect relates to a key for an FPGA in a simple manner.

Accordingly, an apparatus for generating a key in a programmable hardware module is proposed, wherein the programmable hardware module has a bit stream that includes configuration settings of the programmable hardware module. The apparatus has a reading unit for reading at least one part of the bit stream, a generation unit for generating a key based on a cryptographic function and the at least one part of the bit stream, and a memory unit for storing the generated key.

The respective unit, for example the reading unit or generation unit, may be implemented using hardware and/or using software. For an implementation using hardware, the respective unit may be in the form of an apparatus or in the form of part of an apparatus, for example in the form of a computer or in the form of a microprocessor or in the form of a control computer of a vehicle. For an implementation using software, the respective unit may be in the form of a computer program product, in the form of a function, in the form of a routine, in the form of part of a program code or in the form of an executable object.

The reading unit can read a part of the bit stream or can read the whole bit stream. This can be effected directly after loading of the bit stream when the programmable hardware module is switched on or at a particular time at which the configuration of the bit stream is known.

The read data of the bit stream can then be converted into a key by the generation unit using a cryptographic function. This can involve the cryptographic function processing the at least one part of the bit stream in order to generate the key. This generated key can be used for different cryptographic functions.

By way of example, the key can be used as a private key for an encryption in combination with a public key. In this case, the generated key does not have to leave the apparatus.

In this case, the key is not present at or on a specific memory location or hardware circuit within the bit stream, but rather is an edited version of the whole bit stream.

The proposed apparatus means that it is a simple matter for data that are present anyway, i.e. a bit stream already present with configuration settings of a programmable hardware module, to be used to generate a key.

A programmable hardware module is understood to mean an FPGA, for example. Subsequently, the terms programmable hardware module and FPGA are used synonymously.

The apparatus can be realized as a processor in the FPGA. Alternately, the apparatus can be realized as a hardware unit in the FPGA.

In accordance with one embodiment, the generation unit is set up to generate a key continually.

In this case, the data of the bit stream are supplied continually to the generation unit, which shifts them continually into the cryptographic function.

In accordance with a further embodiment, the cryptographic function is a cryptographic compression function.

Any kind of cryptographic compression function that is suitable for generating a key can be used.

In accordance with a further embodiment, the cryptographic compression function is a hash function.

A hash function delivers a hash value as output value, i.e. as a key. Such a hash function can also be used for checking the integrity of the bit stream, for example, as explained in more detail below.

In accordance with the further embodiment, any kind of key derivation function can be used for generating the key from the at least one part of the bit stream.

In accordance with the further embodiment, the memory unit has a volatile memory.

The volatile memory can be erased again at any time, for example if a manipulation is identified. By way of example, the volatile memory can be automatically erased whenever the FPGA is switched off.

In accordance with a further embodiment, the memory unit is set up to store a generated key in the volatile memory continually.

In this case, a key that is already present can be replaced by a freshly generated key.

In accordance with a further embodiment, the reading unit is set up to read the at least one part of the bit stream via an internal configuration interface.

The FPGA has an internal configuration interface via which the apparatus or the reading unit can access the bit stream and read it.

In accordance with a further embodiment, the apparatus has an encryption unit for decrypting the bit stream using a secret key.

In this way, the external bit stream can be protected against attackers. If an attacker wishes to access the bit stream, he first needs to break the encryption in this case. Subsequently, he can analysis only the key generation function or cryptographic function used.

In accordance with the further embodiment, the apparatus has an encryption unit for encrypting parts of the bit stream using the generated key.

The encryption unit can likewise be used for decrypting parts of the bit stream.

In one embodiment, the key can be generated by using an unknown subregion of the bit stream. In this case, an attacker would need to analyze the whole process by means of reverse engineering in order to detect the relevant parts of the bit stream and to analyze the encryption function.

In accordance with a further embodiment, the generation unit is set up to generate the key based on a cryptographic function, the at least one part of the bit stream and an external secret.

In accordance with this embodiment, the key is additionally based on an external secret. Alternatively or additionally, secrets can be used that are hidden in the bit stream, further hampering reverse engineering.

In accordance with a further embodiment, the generation unit is set up to generate a plurality of keys based on a cryptographic function and a plurality of parts of the bit stream.

The bit stream can be split into multiple parts, for example, and a key can be generated based on each part or region. This can also be used to check different parts of the bit stream for their integrity. The plurality of parts of the bit stream may be disjunct sets of the bit stream. Alternatively, the parts of the bit stream may intersect.

In accordance with the further embodiment, the apparatus has a checking unit for checking the integrity of the bit stream using the generated key.

If an attacker manipulates the bit stream, the result of the cryptographic function will differ from a result of the manipulated bit stream. This means that a different key would be generated.

Since the bit stream includes configuration settings of the FPGA, an attacker cannot integrate an additional circuit in order to read the key without altering the bit stream. Therefore, the original key is no longer generated and the attacker can no longer read the original key.

Moreover, other cryptographic functions would likewise no longer work properly, since the bit stream has been altered.

In accordance with a further aspect, a programmable hardware module is proposed that has an apparatus as explained above for generating a key.

In accordance with one embodiment, the programmable hardware module is a field programmable gate array (FPGA).

The FPGA may be an SRAM (static random access memory) based FPGA.

In accordance with a further aspect, a method for generating a key in a programmable hardware module is proposed, wherein the programmable hardware module has a bit stream that includes configuration settings of the programmable hardware module. The method has the following steps: reading at least one part of the bit stream, generating a key based on a cryptographic function and the at least one part of the bit stream, and storing the generated key.

In addition, a computer program product is proposed that prompts the performance of the method as explained above on a program controlled device.

A computer program product, such as e.g. a computer program means, can be provided or delivered as a storage medium, such as e.g. a memory card, USB stick, CD-ROM, DVD, or be provided or delivered in the form of a downloadable file from a server in a network. This can be effected in a wireless communication network, for example, by virtue of the transmission of an appropriate file containing the computer program product or the computer program means.

The embodiments and features described for the proposed apparatus apply to the proposed method accordingly.

Further possible implementations of the invention also comprise not explicitly cited combinations of features or embodiments described above or below for the exemplary embodiments. In this case, a person skilled in the art will also add individual aspects to the respective basic form of the invention as improvements or additions.

### BRIEF DESCRIPTION

Some of the embodiments will be described in detail, with references to the following figures, wherein like designations denote like members, wherein:

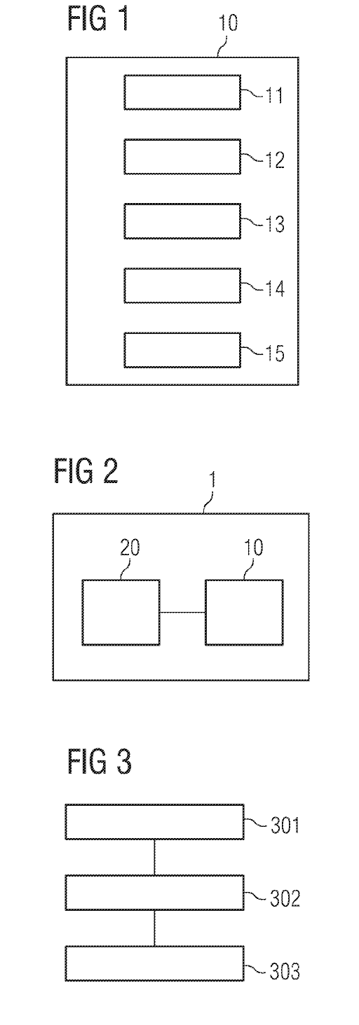

FIG. 1 shows a schematic block diagram of an embodiment of an apparatus for generating a key in a programmable hardware module, in accordance with embodiments of the present invention;

FIG. 2 shows a schematic block diagram of an embodiment of an FPGA with an apparatus according to FIG. 1, in accordance with embodiments of the present invention; and

FIG. 3 show a schematic flowchart for a method for generating a key in a programmable hardware module, in accordance with embodiments of the present invention.

### DETAILED DESCRIPTION

In the figures, elements that are the same or have the same function have been provided with the same reference symbols unless indicated otherwise.

FIG. 1 shows an apparatus 10 for generating a key in the programmable hardware module 1, which is shown in FIG. 2. The programmable hardware module 1 has a bit stream that includes configuration settings of the programmable hardware module 1.

The apparatus 10 has a reading unit 11, a generation unit 12, a memory unit 13, an encryption unit 14 and a checking unit 15.

The reading unit 11 can read one part, multiple parts or can read the whole bit stream via a configuration interface 20.

The generation unit 12 can generate a key based on the read data of the bit stream and a cryptographic function, for example a hash function. In addition, an external secret can also be used.

The generated key can then be stored by the memory unit 13, for example in a volatile memory.

The generated key can be used for different purposes.

Inter alia, the encryption unit 14 can use the generated key to encrypt or decrypt parts of the bit stream. The bit stream can also be encrypted by the FPGA 1 using the generated key.

Another purpose is for checking the integrity of the bit stream. To this end, the checking unit 15 can check the bit stream using the generated key. In the event of manipulation of the bit stream, the originally generated key differs from a hash value of the manipulated bit stream, as a result of which an integrity check can take place.

FIG. 2 shows a programmable hardware module 1. The programmable hardware module may be an FPGA, for example.

The FPGA 1 has an (internal) configuration interface 20. In the FPGA 1, a bit stream is loaded that can be read via the configuration interface 20 by the apparatus 10.

FIG. 3 shows a method for generating a key in a programmable hardware module 1. The method has the steps 301 to 303.

In step 301, at least one part of the bit stream of the hardware module 1 is read.

In step 302, a key is generated based on a cryptographic function and the at least one part of the bit stream.

In step 303, the generated key is stored.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. An apparatus for generating a key in a programmable hardware module, wherein the programmable hardware module has a bit stream that includes configuration settings of the programmable hardware module, comprising:
a reading unit for reading at least one part of the bit stream;
a generation unit for generating a key based on a cryptographic function and the at least one part of the bit stream; and
a memory unit for storing the generated key.

2. The apparatus as claimed in claim 1, wherein the generation unit is set up to generate a key continually.

3. The apparatus as claimed in claim 1, wherein the cryptographic function is a cryptographic compression function.

4. The apparatus as claimed in claim 3, wherein the cryptographic compression function is a hash function.

5. The apparatus as claimed in claim 1, wherein the memory unit has a volatile memory.

6. The apparatus as claimed in claim 5, wherein the memory unit is set up to store a generated key in the volatile memory continually.

7. The apparatus as claimed in claim 1, wherein the reading unit is set up to read the at least one part of the bit stream via an internal configuration interface.

8. The apparatus as claimed in claim 1, characterized by an encryption unit for encrypting the bit stream using the generated key.

9. The apparatus as claimed in claim 1, wherein the generation unit is set up to generate the key based on a cryptographic function, the at least one part of the bit stream and an external secret.

10. The apparatus as claimed in claim 1, wherein the generation unit is set up to generate a plurality of keys based on a cryptographic function and a plurality of parts of the bit stream.

11. The apparatus as claimed in claim 1, characterized by a checking unit for checking the integrity of the bit stream using the generated key.

12. A programmable hardware module, having an apparatus as claimed in claim 1 for generating a key.

13. The programmable hardware module as claimed in claim 12, wherein the programmable hardware module is a field programmable gate array.

14. A method for generating a key in a programmable hardware module, wherein the programmable hardware module has a bit stream that includes configuration settings of the programmable hardware module, the method comprising:
reading at least one part of the bit stream;
generating a key based on a cryptographic function and the at least one part of the bit stream; and
storing the generated key.
